(19) United States
(12) Patent Application Publication
(10) Pub. No.: US 2013/0163711 A1
(43) Pub. Date: Jun. 27, 2013

(54) SOLID INTERFACE JOINT WITH OPEN PORES FOR NUCLEAR FUEL ROD

(71) Applicants: Maxime Zabiego, Pierrevert (FR); Patrick David, Saint Cyr Sur Loire (FR); Alain Ravenet, Vinon-Sur-Verdon (FR); Denis Rochais, Saint Avertin (FR)

(72) Inventors: Maxime Zabiego, Pierrevert (FR); Patrick David, Saint Cyr Sur Loire (FR); Alain Ravenet, Vinon-Sur-Verdon (FR); Denis Rochais, Saint Avertin (FR)

(73) Assignee: COMMISSARIAT A L'ENERGIE ATOMIQUE ET AUX ENERGIES ALTERNATIVES, Paris (FR)

(21) Appl. No.: 13/704,582

(22) PCT Filed: Jun. 16, 2011
(86) PCT No.: PCT/EP2011/059999

§ 371 Date: Feb. 13, 2013

(30) Foreign Application Priority Data
Jun. 16, 2010 (FR) 1054781

(51) Int. Cl. G21C 3/06; G21C 21/02

(52) U.S. Cl. CPC G21C 3/06; G21C 21/02
USPC 376/433; 29/428

(57) ABSTRACT

A new interface between the cladding and the stack of pellets in a nuclear fuel rod. According to the invention, an interface joint made of a material transparent to neutrons, in the form of a structure with a high thermal conductivity and open pores, adapted to deform by compression across its thickness, is inserted between the cladding and the stack of fuel pellets over at least the height of the stack. The invention also relates to associated production methods.

### TECHNICAL DOMAIN

This invention relates to the interface between the stack of pellets and the cladding surrounding them, in a nuclear fuel rod used in a nuclear reactor.

Target applications for the invention include:

gas-cooled fast reactors (GFR) said to be generation IV reactors that operate with a coolant in the form of a gas such as pressurised helium, and use nuclear fuel rods with cladding made of a ceramic matrix composite (CMC) material, and mixed uranium and plutonium carbide type fuel pellets [7];

fast neutron reactors operating with a sodium coolant (SFR) [10];

pressurised water reactors (PWR) or boiling water reactors (BWR).

The invention relates to fuel rods with cylindrical geometry and a circular cross-section.

Throughout this application, the term <<nuclear reactors>> has its normal meaning as understood at the present time, namely power plants for the generation of energy based on nuclear fission reactions using fuel elements in which fission reactions occur releasing thermal power, which is extracted from elements by heat exchange with a coolant fluid that cools them.

Throughout this application, the term <<nuclear fuel rod>> has its official meaning as defined for example in the Dictionnaire des Sciences et Techniques nucléaires (Nuclear Sciences & Techniques Dictionary), namely a narrow small diameter tube closed at both ends, forming part of the core of a nuclear reactor and containing fissile material. Thus, <<nuclear fuel rod>> is the term used in preference in this invention.

### PRIOR ART

There are different types of fuel rods depending on operating conditions and the performances of nuclear reactors.

The main functions to be performed by a nuclear fuel element are to:

enable controlled production of heat by nuclear reactions, which imposes performance constraints (density of fissile nuclei, transparency of structural materials to neutrons, burnup fraction, etc.) and safety constraints (geometric stability necessary for control of the nuclear reactivity and cooling);

assure confinement of radioactive products originating from nuclear reactions, which means that the cladding must remain leak tight during nominal operation of the reactor, and any loss of leak tightness must remain within predefined release limits in an accident situation;

guarantee controlled extraction of energy released by nuclear reactions, which imposes performance constraints (limitation of thermal barriers that could degrade transfers to the coolant) and safety constraints (integrity of the coolant channel, margin before melting of the fuel, limitation of temperature gradients that cause differential expansion that could lead to an excessive mechanical load on structures, etc.).

Basic fuel elements conventionally encountered in nuclear installations may be classified as a function of their geometry as follows:

spheres: for example, particles or balls of fuel for High Temperature Reactors (HTR)

cylinders: fuel rods, for example for FNR reactors or PWR reactors;

plates: for example, micro-structured plates for experimental reactor fuels or macro-structured plates for GFR reactors.

The invention exclusively concerns nuclear fuel rods with cylindrical geometry and circular cross-section in which cylindrical fuel pellets with a circular cross-section are stacked in a sealed tubular cladding with a zone at one of its ends without any pellets called the expansion vessel, which stores gases produced by nuclear reactions and released by fuel pellets during irradiation. In this cylindrical configuration, there is an interface between the column of stacked pellets and the cladding. Up to now, this interface might be reduced during assembly to a contact surface only or it might correspond to a functional clearance that may then be composed of one or several materials in gas or liquid form or in layers, as explained below.

The inventors have made a list of functions to be performed by this interface in a fuel element. They are described below.

Primary Functions:

f1/ manage mechanical decoupling between fuel pellets and the cladding, so as to limit mechanical interaction between pellets and the cladding (this interaction is hereinafter referred to as PCMI), by enabling free expansion of the column of stacked pellets along a radial direction and an axial direction;

f2/ enable transport of gas fission products released by the fuel element as far as the expansion vessel located at the axial end of the fuel element;

f3/ manage thermal coupling between the fuel and the cladding:

i. minimising thermal barriers, particularly along the radial direction, to prevent any excessive temperature rise of the fuel;

ii. guaranteeing continuity of this function, particularly along the axial and azimuth directions, so as to minimise temperature heterogeneities that can cause differential expansion that could in particular induce large mechanical loads on the cladding.

Functions Induced by the Environment:

f4/ perform primary functions (f1 to f3) minimising the neutron impact at the interface, so as to preserve performances of the reactor core:

i. by minimising the geometric dimensions;

ii. by making use of materials with a small interaction cross-section with neutrons (particularly in the fast spectrum).

f5/ perform primary functions (f1 to f3) guaranteeing chemical compatibility of the interface with its environment:

i. guaranteeing chemical compatibility of the interface with the cladding (no increase in rates at high temperature, for example under accident condition);

ii. guaranteeing chemical compatibility of the interface with the fuel (no <<low temperature>> eutectic that could for example reduce the fuel melting margin).

Secondary Functions:

f6/ limit transfer of constituents from the fuel (particularly released fission products) to the cladding, to prevent the risk of internal corrosion that could cause embrittlement that might occur as a result of this transfer; this is a function related to the primary function f1;

f7/ optimise fuel/cladding centring so as to minimise temperature heterogeneities that cause hot points and increased mechanical loads at the cladding; this is a secondary function related to primary functions f1 and f3;

f8/ minimise (without introducing) the risk of the movement of fuel splinters into the clearance, if any, between the fuel and the cladding, that could cause an integrity defect in the cladding by ovalling and/or punching of the cladding when this clearance is reduced under the effect of differential strains (thermal expansion and swelling); this is a function related to the primary function f1.

Auxiliary Functions:

f9/ satisfy usual economic constraints:

i. life: perform primary and secondary functions for a fuel operating time compatible with target economic performances;

ii. capacity for procurement of materials and implementation of fabrication methods;

iii. cost.

f10/ exclude any significant prejudice to safety in an accident condition (for example, chemical reactivity of the interface with structural materials in the core during an advanced core degradation phase);

f11/ minimise technical fabricability problems, particularly implementation of the fuel element assembly process (fuel, interface and cladding);

f12/ satisfy separation and recycling requirements on the output side of the nuclear reaction cycle, with minimum constraints.

The interface between pellets and cladding in fuel elements with circular geometry and circular cross-section is usually in the form of a gas, typically helium, which has optimum properties (among possible gases) regarding thermal conductivity (function f3.i), transparency to neutrons (function f4.ii), chemical neutrality (function f5) and auxiliary functions (functions f9 to f12). Functions for mechanical decoupling between fuel pellets and cladding (function f1) and transport of fission gases to the expansion vessel (function f2) are ideally performed by an interface in gas form, provided that a sufficient functional clearance is created during fabrication between pellets and cladding to prevent filling of the gap under irradiation due to differential strains of the fuel and the cladding [5].

However, a rod with cylindrical geometry and a circular cross-section and an interface in gas form shows antagonism because it cannot perform firstly functions f1 and f2 and secondly functions f3i and f4.i simultaneously, except within very strict performance limits. Beyond the dimensional constraints that adversely affect neutron performances (density of fissile material in the fuel element), since the thermal conductivity of the gas interface is relatively mediocre, any increase in the functional clearance between pellets and the cladding will increase the thermal barrier that it forms, leading to increased temperatures of the fuel. Apart from the fact that the temperature increase takes place at the detriment of safety requirements (particularly a reduction in the fuel melting margin), it is accompanied by an increase in the three-dimensional expansion of the pellet that tends to reduce said gap under irradiation, thus reducing the efficiency of the increased thickness of the interface and consequently the increase in the life of the fuel element.

One solution to reduce this thermal prejudice has been disclosed in patent JP 11183674 and in which experiments have been made in various experimental irradiation programs [8], [9]. This solution consists of making the interface no longer in gas form but rather in the form of a metal with a low melting point and that is liquid under operating conditions of the fuel element, generally sodium. The conductivity of the metal is higher than that of gas and can thus considerably reduce problems related to conductance of the interface, which then makes a negligible contribution to the thermal balance of the fuel element and potentially makes greater interface thicknesses possible.

Another advantage of having an interface in liquid metal form is that it reduces circumferential thermal heterogeneity problems resulting from possible eccentricity of the fuel pellet relative to the cladding, due to its good thermal conductivity. The concentricity requirement (function f7) is not a priori guaranteed by an interface in gas or liquid metal form, due to the lack of rigidity of a liquid metal or a gas. Any eccentricity will also mean that the heat flux is heterogeneous around the circumference. The consequences of this thermal heterogeneity (hot point at the cladding and mechanical load induced by differential thermal strains) are thus attenuated when the interface is in the liquid metal form due to better heat transfers firstly between the liquid metal and the cladding and secondly between the liquid metal and the pellets.

However, the interface in liquid metal form cannot be made without creating some problems.

Firstly, compatibility with the environment (function f5, for example for chemical aspects), is found to be very restrictive. Thus in the case of sodium, that is naturally applicable for SFRs, there is clearly an incompatibility with a water coolant (PWR), and with a reactor operating at high temperature and consequently leading to an insufficient margin (or even non-existent margin, for example in the case of the GFR) against the risk of sodium boiling (the sodium boiling temperature is of the order of 880° C.).

Concerning thermal heterogeneities (function f3.ii), it is clear that any discontinuity in the interface induced by the presence of gas bubbles in the liquid metal (bubbles formed during fabrication or by fission gases released under irradiation), would mitigate the thermal benefits of this solution: this problem was observed during experimental irradiation during which it was seen that it could lead to a premature end of life of the fuel element due to early failure of the cladding [9]. Furthermore, concerning the limitation of fuel constituent transfers (function f6), experimental irradiations of carbide fuels in SFR type reactors with the purpose of comparing the behaviour of helium and sodium interfaces have shown that the liquid metal contributes to embrittlement of the cladding due to carburization of the cladding induced by an increased transfer of carbon originating from fuel through the sodium, although this problem does not appear to arise through helium [9], unless there is pellet/cladding contact due to eccentricity. Finally, concerning function f8, the lack of inherent stiffness of the joint enables movement of fuel splinters which, if they move into the interface, could lead to ovalling or punching of the cladding by compression of the splinter between pellets and cladding during irradiation. Such punching implies a premature loss of the cladding integrity/seal safety function, while ovalling will degrade performances because it affects heat exchanges and mechanical interactions, if any, between nearby fuel elements. In practice, operating experience with irradiation of fuel elements shows that an initial value of the radial functional clearance between pellets and cladding of less than about 4% of the radius of fuel pellets can minimize the risk of cladding failure by punching, by limiting the probability of a fuel splinter moving into the interface [11]. This limit, made necessary by safety requirements, nevertheless has proved to be relatively prejudicial to the operating life of the fuel element, in that it substantially reduces the operating life without PCMI. In this context, long term use of a fuel in a nuclear reactor, necessary for its economic performances, will make functioning with PCMI inevitable during a variable time period before the end of life. In this case, direct contact between the fuel pellets and the cladding also creates the problem of damage to the cladding by fission products that penetrate into it over a thickness of a few micrometers, due to their recoil energy.

Various solutions have been proposed to enable acceptable operation with PCMI regarding economic and safety performances.

They are aimed at overcoming two residual difficulties that neither the interface in gas form nor the interface in liquid metal form can solve individually, namely:

the need to reduce the mechanical load imposed on the cladding in a situation of contact with the fuel;

minimising embrittlement of the cladding due to thermochemical aggressions and fission peaks.

All proposed solutions consist of depositing one or several intermediate layers of materials, as all or part of the interface.

Patent GB 1187929 discloses the use of an intermediate layer between fuel pellets and the cladding, based on metal uranium, for a fuel rod with metal cladding operating at a temperature of at least 700° C. in an FNR reactor. This patent describes:

intimate contact between the intermediate layer and the cladding;

another part of the interface performing a temperature function, typically made of sodium, between the intermediate layer and the cladding;

an additional layer performing a chemical compatibility function, typically alumina, between the intermediate layer and the cladding;

grooves forming vacuum zones between the fuel and the intermediate layer;

the possibility that the porosity of the intermediate layer and/or the fuel pellet will be such that its (their) density will be equal to not more than 85% of its (their) theoretical density;

uranium alloy, or uranium and molybdenum alloy as constituents of the intermediate layer.

Similar solutions have been disclosed for fuel rods with zirconium-based cladding used in PWR reactors.

Thus, U.S. Pat. No. 4,818,477 discloses how to make a liner based on consumable neutron poisons (boride enriched in ¹⁰B), coating fuel pellets with a thickness of between 10 μm and 100 μm, so as to attenuate the PCMI.

U.S. Pat. No. 3,969,186 discloses how to make a metal liner deposited on the inner face of the cladding, so as to prevent the risk of perforation or failure of the cladding induced by stress corrosion cracking and/or pellets/cladding mechanical interaction.

U.S. Pat. No. 4,783,311 discloses how to make a combination of liners on the inner face of the cladding (thickness from 4 μm to 50 μm) and on the surface of fuel pellets (thickness from 10 μm to 200 μm), the liner on the inner face of the cladding, from a material such as graphite, particularly performing a [symbol] lubricant [symbol] role.

Patent JP 3068895A discloses how to make a ductile intermediate layer provided with grooves, to absorb stresses induced by a potential PCMI, the layer being plastically deformable thus avoiding propagation of cracks on the inner face of the cladding.

There are also fuel particles with a spherical geometry used in HTR reactors, as described in international patent application WO2009079068. As described in this application, a multilayer structure is made with a fuel ball at the centre and a surrounding cladding, providing mechanical integrity and a seal for fuel ball fission gases, and between which a porous pyrocarbon layer performing a buffer function is deposited in order to create an expansion volume for fission gases and the fuel ball.

U.S. Pat. No. 4,235,673 discloses the use of a sleeve, either in the form of a fabric of metal wires (embodiment in FIGS. 1 and 2) or in the form of metal ribbons (embodiment in FIGS. 3 and 4), wound helically about the column of fuel pellets, fixed to closing elements at the ends of the column of fuel pellets and the sleeve being inserted between the column of fuel pellets and the cladding. This technological sleeve solution according to this patent U.S. Pat. No. 4,235,673 is aimed exclusively at confining pellet fragments or splinters that might be created. Thus, the only function of the sleeve according to this patent U.S. Pat. No. 4,235,673 is to confine fuel pellet splinters, and the function to transfer heat between the pellets and cladding is necessarily done by an infill fluid such as sodium as explained for example in column 4, lines 23-30 in this document and the function accommodating three-dimensional swelling of pellets is done through the compulsory existence of a functional clearance between the sleeve and cladding sized for this purpose, as is very clearly expressed in the text in claim 1 of this document. In other words, U.S. Pat. No. 4,235,673 discloses a necessarily composite interface solution between the sleeve fixed to the ends of the pellet column and a sufficiently large thickness of heat transfer liquid between the cladding and the pellet column to define a functional clearance sufficiently large to accommodate the three-dimensional swelling of the pellets. Furthermore, the combined interface solution according to this patent U.S. Pat. No. 4,235,673 is complex to implement and introduces risks of non-reproducibility, due to the sleeve being fixed to closing elements at the ends of the fuel pellet column, which therefore requires an additional step during fabrication of a fuel rod in a nuclear environment.

Therefore, the general purpose of the invention is to propose an improved interface between pellets and cladding in a nuclear fuel rod with a cylindrical geometry and circular cross section that does not have the disadvantages of interfaces according to prior art as presented above.

Another purpose of the invention is to propose a method for fabricating a nuclear fuel rod with an improved pellet/cladding interface that is not completely unrelated to the industrial facility set up to fabricate existing nuclear fuel rods with circular cross-section.

### PRESENTATION OF THE INVENTION

To achieve this, the purpose of the invention is primarily a nuclear fuel rod extending along a longitudinal direction comprising a plurality of fuel pellets stacked on each other and a cladding made of a material transparent to neutrons surrounding the stack of pellets, in which the cladding and the pellets have a circular cross-section transverse to the longitudinal direction, and in which an interface joint also with a circular cross-section transverse to the longitudinal direction, made of a solid material transparent to neutrons and with open pores is inserted between the cladding and the column of stacked pellets, at least over the height of the column.

According to the invention, the interface joint is a structure, mechanically decoupled from the cladding and from the column of pellets, with a high thermal conductivity and open pores, adapted to deform by compression across its thickness so as to be compressed under the effect of the three-dimensional swelling of the pellets under irradiation, the initial thickness of the joint and its compression ratio being such that the mechanical load transmitted to the cladding by the pellets under irradiation is less than a predetermined threshold value.

A high thermal conductivity means a coefficient of thermal conductivity sufficiently high to achieve heat transfer between the column of pellets and the cladding. Preferably, the objective is to increase the heat transfer by a factor of at least 10 with respect to a gas like helium.

Therefore the invention concerns an interface joint between the stacked pellets and the cladding, in the form of a solid structure with high porosity, preferably between 30 and 95% of the volume of the joint in the cold state and that is adapted to perform the following functions up to nominal operating temperatures in nuclear reactors:

due to its compression, enable radial expansion of the stacked fuel pellets under irradiation, without any excessive mechanical load on the cladding;

due to deformations not causing loss of continuity of its structure, enable accommodation of differential axial strains between the stacked pellets and the cladding surrounding them, at a high temperature and under irradiation without an excessive load on the cladding;

facilitate transfer of heat generated by nuclear reactions within the pellets, to the coolant circulating along the cladding, in a uniform manner;

enable the transfer of fission gases and/or helium released under irradiation to the expansion vessel located at the end of the cladding and in which there is no fissile material;

protect the cladding against compatibility problems with the fuel in the pellets, either by damping recoil fission products, by retention of solid and volatile fission products released by the fuel in the pellets and that could corrode the cladding, or by control of the stoichiometry of the fuel.

The interface joint according to the invention may be made in any nuclear fuel rod for use in reactors in which the coolant is either pressurised (as for GFR reactors) or is not pressurised. For pressurised coolants, care will be taken to assure that the cladding used is sufficiently resistant to creep deformation so that it will not come into contact with the fuel pellets during operation. Typically, cladding made of a CMC is perfectly suitable.

Fuel rods with an interface joint according to the invention may be used for the production of power, heat and/or neutron flux (with severe thermal and neutron constraints) or as means of managing the fuel cycle (transmutation targets loaded with minor actinides, with swelling constraints made more severe by the large quantities of helium produced under irradiation).

For all the envisaged applications, a solid interface joint is defined with open pores that durably enable three-dimensional expansion of the fuel without applying an excessive mechanical load on the cladding, up to burnup fractions that can locally reach 15 to 20 at %. Note that the conventional definition of at % is a unit denoting the percent of fissile atoms burnt up. “Excessive” means any load, particularly in the circumferential direction, that could exceed limits imposed by usual design criteria for a nuclear fuel [12]. Note also the thermal constraints (performances and lack of discontinuities) neutron constraints (transparency to neutrons and dimensions) and constraints on the transfer of fission gases released to the expansion vessel also have to be respected.

One or more materials for the interface joint according to the invention could be used, that would contribute to making non-mechanical interactions between the fuel and the cladding material unimportant. Thus, concerning neutron damage, the solid interface joint can absorb all or some of the recoil fission products that could cause damage within the thickness of the cladding (a few micrometers on the inner face). Furthermore, the solid interface joint with open pores which can:

due to their large exchange surface area, trap some or all solid and volatile fission products released by the fuel that can react chemically with the cladding and degrade its mechanical performances (for example stress corrosion problem);

control the stoichiometry of the fuel by performing the role of a <<chemical buffer>> between the fuel and the cladding material, which can be conducive to maintaining a large margin against local melting of the fuel by avoiding the formation of metallic precipitates with low melting points. This is the case particularly for a mixed uranium and plutonium carbide fuel, currently being envisaged for a GFR reactor. Operating experience [9] thus shows that initial over-stoichiometry of the fuel that is essential for good performance, tends to drop under irradiation as the carbon is [symbol] consumed [symbol] by fission products and chemical reactions with the cladding. An interface joint based on carbon may also be an efficient source of free carbon capable of limiting decarburization of the fuel.

The open pores of the joint and any gaps separating the interface joint from the fuel pellets and/or the cladding may be filled with a gas, preferably helium and/or a liquid metal such as sodium.

Due to is consistence (intrinsic stiffness up to the mechanical load threshold beyond which it starts to be compressed), the solid interface joint according to the invention guarantees centring of the fuel pellets in the cladding and prevents any movement of fuel fragments.

One way of creating a long-term delay in the PCMI for local burnup fractions of up to 15 to 20 at % would be to envisage a solid interface joint several hundred microns thick (in comparison with typical values of about a hundred microns in usual configurations with a gas or liquid metal joint). In any case, care will be taken to assure that its thermal properties, possibly taking account of the thermal properties of the gas and/or the liquid metal in which it is immersed, guarantee control of the temperature of the fuel, such as the margin to melting.

Care will be taken to make sure that the solid interface joint has ad hoc mechanical properties. Thus, care will be taken to assure that it has sufficiently high strain capacities in compression, in other words radially along the direction of the fuel rod, and in shear (around the circumference and along the direction parallel to the axis of revolution of the rod), to accommodate differential strains of fuel pellets and the cladding under irradiation, without inducing any excessive mechanical load on the cladding, or any axial and circumferential discontinuity of the joint. These mechanical properties must be guaranteed under irradiation for doses of up to the order of 100 dpa-Fe to 200 dpa-Fe (fluences from 2 to 4×10²⁷ n/m²). Fuel pellets are subject to three-dimensional swelling, such that their diameter and length increase. Since the cladding a priori swells much less than the fuel, the interface between pellets and the cladding reduces during irradiation. Furthermore, the stack of pellets extends much more than the cladding, causing longitudinal shear between them. Thus, care will be taken to assure that the interface joint can:

due to its compression strain, compensate for reduction of the interface with a stiffness compatible with the mechanical strength of the cladding, which excludes the presence of any locally dense zones (defects resulting from the fabrication method, densification in irradiation, etc.);

compensate for the longitudinal sliding deformation between the fuel column and the cladding by its elongation (effect of Poisson's ratio) resulting from its radial compression and/or by shear deformation (assuming surface sticking on the cladding and/or the fuel with transmission of an axial force compatible with the mechanical strength of the cladding); and/or by a viscous axial extrusion flow into the gap under the action of its radial compression.

The interface joint according to the invention is made continuously over its entire height: in any case, the objective is to reach a compromise such that by compensating for the longitudinal sliding deformation described above, no axial discontinuity of the joint occurs.

Also, care will be taken to assure that cohesion between the interface joint and the pellets does not prevent the release of fission gases through the surface.

Finally, care will be taken to assure that joint deformation modes do not cause fragmentation of the joint in a way that could lead to fragments moving when the interface is partially reopened, typically during an unscheduled or scheduled reactor shutdown, which would induce a risk of later punching of the cladding, for example when the power/temperature rise.

Care will also be taken to assure that the neutron properties of the solid interface joint are such that it has the lowest possible impact on the neutron balance in the core of the nuclear reactor. Thus, the high open porosity of the joint according to the invention aims at minimising its residual volume once it has been fully compressed. Care will be taken to assure that the material(s) to be envisaged for the solid interface joint is (are) as transparent to neutrons as possible, for fuel rods.

The high open porosity of the structure as fabricated must facilitate transport of released fission gases to the expansion vessel located near the top of the fuel element, with an efficiency that does not degrade much under irradiation (compression of the structure leading to a reduction in the total porosity and the open pores ratio).

The large exchange surface area provided by the structure must facilitate retention of solid fission products released by the fuel under irradiation that might contribute to embrittlement of the cladding by stress corrosion.

Due to the structural interface joint according to the invention, it can be thicker than is possible with interfaces usually encountered between the pellets and cladding, so as to extend the life of fuel pellets, resulting in an appreciable economic saving without affecting safety (for example, margin to melting of the nuclear fuel).

The open pores of the interface joint according to the invention may have a volume equal to at least 30% of the total volume of the interface joint as produced in fabrication. Preferably, this volume is between 30% and 95% of the total volume of the interface joint as produced in fabrication and is more preferably between 50% and 85%.

Obviously, the described porosity and geometric dimensions of the interface joint are those for the cold interface joint as produced in fabrication and before it is used in a nuclear reactor.

The same is true for other elements of the fuel rod according to the invention.

The open porosity targeted by the invention may be quantified by various known measurement techniques: for example density measurement for braids and fibres, or for example image analysis by X tomography or optical microscopy or optical macroscopy.

Advantageously, the thickness of the interface joint in its section transverse to the (XX′) direction is more than at least 4% of the radius of the pellets.

The interface joint may be composed of one or several fibrous structures such as braid(s) and/or felt(s) and/or web(s) and/or fabric(s) and/or knit(s). Its volume percentage of fibres is then advantageously between 15 and 50%, which corresponds approximately to a porosity of between 50 and 85%, in other words an optimum compromise between the required joint compressibility and high thermal conductivity accompanied by effective confinement of any fuel splinters that might be formed. According to one embodiment, the interface joint may be made from a braid comprising a carbon fibre layer and a layer comprising silicon carbide fibres superposed on the carbon fibre layer.

Alternately, the interface joint may be made from one or several honeycomb materials such as foam.

The interface joint may be based on ceramic or metal.

For a gas-cooled fast reactor (GFR), the basic material of the cladding could preferably be envisaged to be a refractory ceramic matrix composite (CMC) such as SiC—SiC_{f}, possibly associated with a liner based on a refractory metal alloy, and fuel pellets made of ceramic materials such as (U, Pu) C, (U, Pu)N or (U, Pu)O₂.

For a sodium-cooled fast reactor (SFR), it would be possible to envisage the cladding made of a metallic material, and fuel pellets made of ceramic materials such as (U, Pu)C, (U, Pu)N or (U, Pu)O₂ or metallic materials such as (U, Pu)Zr. According to one variant, the open porosities of the interface joint and the spaces between the cladding, pellets and rod closing elements are then filled with a gas, preferably helium. According to another variant, the column of stacked pellets bears in contact with a closing element at the bottom of the rod such that during operation in a nuclear reactor, the open pores of the interface joint and the spaces between the cladding, pellets and the closing element at the bottom of the rod are filled with sodium over the height of the column and the space between the top of the column and the closing element is filled with helium.

For a pressurised water reactor (PWR) or a boiling water reactor (BWR), the cladding could preferably be made from a refractory ceramic matrix composite (CMC) material and the fuel pellets could be made from ceramic materials such as UO₂, (U, Pu)O₂.

The invention also relates to a nuclear fuel assembly comprising a plurality of fuel rods as described above and arranged together in the form of a lattice.

Finally, the invention relates to a method for making a nuclear fuel rod comprising the following steps:

a/ at least partially make a joint with a circular cross-section made of a material transparent to neutrons, in the form of a structure with good thermal conductivity with open pores, capable of deforming under compression across its thickness;

b/ insert the at least partially produced joint into a cylindrical cladding with a circular cross-section that is open at least at one of its ends, made of material that may or may not be transparent to neutrons;

c/ introduce a plurality of nuclear fuel pellets over not more than the height of the joint, inside the joint inserted into the cylindrical cladding with circular cross-section;

d/ completely close the cladding once the joint has been entirely produced.

According to a first embodiment, step a/ is made using the following sub-steps:
superpose a braid layer comprising silicon carbide fibres on a carbon fibre braid layer itself on a mandrel;
compress the two-layer braid in a cylindrical mould;
add a soluble binder into the compressed braid;
evaporate the solvent;

step b/ is done using the mandrel around which the braid is in contact, the mandrel then being removed;

and later in step c/, a heat treatment is performed under a vacuum to eliminate the binder and thus bring the joint into contact with the plurality of stacked pellets and with the cladding. The braid layers may be of the two-dimensional type with a braiding angle of 45° relative to the axis of the mandrel.

The carbon fibres may be of the Thornel® P-100 type, each containing 2000 filaments and cracked.

The silicon carbide fibres are of the HI-NICALON™ type S each containing 500 filaments.

The soluble binder is advantageously a polyvinyl alcohol.

According to a second embodiment, step a/ is performed using the following sub-steps:

needlebonding of carbon fibre webs in the form of a tube on a mandrel;

performance of a heat treatment (for example at 3200° C. under Argon);

compression of the heat-treated tube in a cylindrical mould;

addition of soluble binder into the compressed tube; evaporation of the solvent;

step b/ is done using the mandrel around which the tube is in contact, the mandrel subsequently being removed;

and later in step c/, a heat treatment is performed under a vacuum to eliminate the binder and thus bring the joint into contact with the plurality of stacked pellets and with the cladding.

The carbon fibres may then be of the Thornel® P-25 type.

As in the first embodiment, the soluble binder is advantageously a polyvinyl alcohol.

According to a third embodiment, step a/ is done using the following sub-steps:

production of a carbon foam tube composed of open honeycombs;

chemical vapour deposition (CVD) of a W—Re alloy on the carbon foam tube.

### BRIEF DESCRIPTION OF THE DRAWINGS

Other advantages and characteristics of the invention will become clear after reading the detailed description of a nuclear fuel rod according to the invention with reference to FIGS. 1 and 1A below among which:

FIG. 1 is a partial longitudinal cross-sectional view of a nuclear fuel rod according to the invention;

FIG. 1A is a cross-sectional view of the nuclear fuel rod according to FIG. 1;

FIG. 2 shows cyclic compression tests of an interface joint according to the invention in the form of curves, this load mode being representative of operation under irradiation in a nuclear reactor (non-stationary due to power variations).

### DETAILED DESCRIPTION OF PARTICULAR EMBODIMENTS

Note that the element shown is a nuclear fuel rod. This element is shown cold, in other words once the final fuel rod has been fabricated and before use in a nuclear reactor.

The nuclear fuel rod according to the invention comprises the following from the outside to the inside:

cladding 1 made of a metallic or CMC (ceramic matrix composite) material(s), possibly coated with a liner on its inner wall;

a first assembly set 2 (optional), to the extent that it may possibly be eliminated during fabrication following the binder evaporation process described above);

a solid joint 3 with open pores according to the invention;

a second assembly set 4 (optional, to the extent that it can possibly be eliminated during fabrication following the binder evaporation process described above);

a stack of nuclear fuel pellets 5 forming a column for the nuclear fuel rod.

The solid joint with open pores 3 according to the invention has a height greater than the height of the column of stacked pellets 5. The difference in height between the porous solid joint 3 and the column of stacked pellets is chosen to assure that this column remains axially facing the joint throughout the irradiation phase during operation of the nuclear reactor during which its length increases due to swelling under irradiation. In the case of mixed uranium and plutonium carbide type fuel pellets used in a GFR reactor, for example, the inventors believe that the average elongation of the column of pellets in the most severely loaded rod can be of the order of 0.5%/at %, which gives an elongation of the order of 10% at the target burnup fractions. Thus in this case, it is planned to use a porous solid joint 3 with a height equal to at least 10% more than the height of the column of stacked pellets 5. Several types of materials may be suitable for fabrication of the porous solid joint 3 according to the invention, and advantageously fibrous structures possibly with matrices deposited in these structures, or honeycomb materials with open pores.

Fibrous structures that may be suitable include braids, felts, webs, fabrics or knits, or a combination of them, comprising a volume percentage of fibres equal to at least 15%, or possibly at least 5% in the case of felts, before densification. The fibres may be made of ceramic compounds (carbon, carbides, nitrides or oxides) or metallic compounds (such as W, W—Re alloys, Mo—Si₂, etc.). One way of making fibrous structures suitable for a porous joint 3 according to the invention may be to use conventional braiding, felt forming or webbing, needlebonding, weaving or knitting techniques [4].

It is possible to envisage increasing the thermal conductivity of the material or protecting the fibres by depositing chemical compounds that are also refractory (ceramic or metallic compounds) on the fibres. These depositions then represent a volume percentage such that the open porosity of the final material, fibrous structure reinforced by a deposition, is between 30% and 85%, or even up to 95% in the case of felts. These depositions on fibrous structures may be made using conventional chemical vapour deposition (CVD) techniques [1] or other techniques such as impregnation of ceramic polymer precursor, pyrolysis, etc.

The joint 3 may be placed either by positioning it around the pellets 5 and then inserting the joint 3/pellets 5 assembly into the cladding 1, or by inserting it into the cladding 1, the pellets then being inserted later.

Physical contact firstly between the cladding 1 and the joint 3 and secondly between the joint 3 and the pellets 5 may be formed by differential thermal expansion during the temperature rise in the nuclear reactor, since joint 3 expands more. Another way of achieving this physical contact is radial compression of the joint 3, and then the joint 3 can expand after placement of the cladding 1-joint 3-pellets 5 assembly, before the assembly is put into service in the nuclear reactor in which the fuel rod is to be used.

Honeycomb materials or foams that might be suitable are open pore materials with between 30% and 85% of porosity, with cell diameters preferably less than 100 μm to prevent movement of “macro-fragments” of pellets, but sufficiently large for interconnection of the pores. The composition of these materials may be based on ceramic or metallic compounds. It would be possible to make honeycomb materials suitable for porous joints 3 according to the invention using conventional techniques for the injection of gas bubbles or compounds generating bubbles in the molten material or a precursor compound (organic resin for carbon), powder metallurgy with porogenic compounds or particles, deposition of a compound on a foam acting as a substrate [2],[6]. The basic foam can then be reinforced by deposition of a compound (among ceramic or metallic compounds) with a nature that may be identical to or different from the foam compound. This deposition may for example be obtained by chemical vapour phase deposition (CVD) [1].

Three examples of nuclear fuel rods according to the invention are given below: in all these examples, the fuel rod comprises a stack of nuclear fuel pellets 5 with a diameter of 6.4 mm and cladding 1 surrounding the column of stacked pellets with an inside diameter of 7.2 mm, namely a total radial thickness assembly clearance of 400 μm (cold).

For comparison, for a GFR carbide fuel, if the gap were filled with a helium joint, a radial thickness clearance of 150 μm would be chosen (cold) for such fuel pellets so that a burnup fraction of the order of 7.5 at % maximum could be achieved.

With a porous solid joint according to the invention, and considering the end of life reached for complete disappearance of the joint porosity (by compression under three-dimensional expansion of fuel pellets), the gain on the burnup fraction that could be envisaged from the design fabrication porosity for the joint according to the invention can be evaluated. For a change from a thickness of 150 μm to 400 μm, the required value of the joint porosity is typically a value equal to a ratio of 150/400, namely of the order of 40% (joint with 60% of the theoretical density of the material of which it is composed), to achieve the burnup fraction of the 150 μm thick helium joint, and also to benefit from the advantages mentioned above (centring of the pellets in the cladding, protection against movements of fuel splinters into the clearance). Note that the thermal effect induced by the joint is neglected (calculations show that this is a second order effect concerning the swelling ratio of the fuel).

Therefore, the burnup fraction with this 40% porosity can typically be doubled by doubling the joint and therefore changing its thickness to 800 μm, but this value can naturally be reduced by increasing the fabrication porosity of the joint; with a porous solid joint with a porosity of the order of 75%, it would be possible to envisage doubling the burnup fraction with a thickness of 400 μm.

### Example 1

### Braid with SiC Layer/C Layer

A first braid layer is made with carbon fibres (trade name Thornel® P-100 each containing 2000 filaments and that are cracked to reduce the thread diameter) on a mandrel with the following characteristics:

inside diameter: 6.5 mm

outside diameter: 7.0 mm

braiding type: 2D

braiding angle: 45°

A second braid layer is made on the previous series of braid layers with silicon carbide fibres (trade name HI-NICALON™ type S each containing 500 filaments), with the following characteristics:

inside diameter: 7.0 mm,

outside diameter: 7.4 mm

braiding type: 2D

braiding angle 45°

The two-layer braid 3 thus formed is compressed in a cylindrical mould with an inside diameter of 7.1 mm. An eliminable soluble binder, in this case a polyvinyl alcohol, is then added into the braid and the solvent is then evaporated.

The braid 3 is then stripped and inserted into a metal cladding 1 with inside diameter of 7.2 mm. The central mandrel is then removed, and a column of 6.4 mm diameter fuel pellets 5 is then inserted into the braid. The binder is eliminated by heat treatment of the assembly under a vacuum. The braid 3 then expands and comes into physical contact with the fuel pellets 5 and the cladding 1.

Therefore, the fabricated thickness of the braid 3 is equal to the total assembly clearance between the cladding 1 and the pellets 5, namely 400 μm.

The cladding 1 may then be closed at its ends, for example by welding. Even if not shown, before the final closing step is done, a helical compression spring is housed in the expansion chamber or vessel 6 with its lower end bearing in contact with the stack of pellets 5 (possibly an inert packing or spacer not shown) and its other end bearing in contact with the upper plug. The main functions of this spring are to hold the stack of pellets 5 along the direction of the longitudinal axis XX′ and to absorb the elongation of the fuel column with time under the effect of longitudinal swelling of the pellets 5.

The nuclear fuel rod thus made with a porous solid joint 3 according to the invention can then be used for application in a nuclear reactor.

### Example 2

### Carbon Needlebonded Structure

Carbon fibre layers (trade name Thornel® P-25) are needlebonded in the form of a tube with inside diameter 6.5 mm and outside diameter 7.4 mm, on a graphite mandrel.

A heat treatment is then applied on the assembly at 3200° C. under Argon. The tube thus formed is compressed in a cylindrical mould with an inside diameter of 7.1 mm. An eliminable soluble binder, in this case a polyvinyl alcohol, is then added into the structure and the solvent is then evaporated.

The porous solid joint 3 thus obtained is then stripped and inserted into a cladding 1 with inside diameter of 7.2 mm. The central mandrel is then removed, and a column of 6.4 mm diameter fuel pellets 5 is then inserted into the mixed joint 3/cladding 1 structure.

The binder is then eliminated by heat treatment of the assembly under a vacuum. The joint 3 then expands and comes into contact with the stacked fuel pellets 5 and the cladding 1.

The cladding 1 may then be closed at its ends, for example by welding. Even if not shown, before the final closing step is done, a helical compression spring is housed in the expansion chamber or vessel 6, also called the plenum, with its lower end bearing in contact with the stack of pellets 5 (possibly an inert packing or spacer not shown) and its other end bearing in contact with the upper plug. The main functions of this spring are to hold the stack of pellets 5 along the direction of the longitudinal axis XX′ and to absorb the elongation of the fuel column with time under the effect of longitudinal swelling of the pellets 5. The nuclear fuel rod thus made with a porous solid joint 3 according to the invention can then be used for application in a nuclear reactor.

### Example 3

### Carbon Foam Coated with a W—Re 5% Alloy

A tube with an inside diameter of 6.4 mm and outside diameter of 7.2 mm made of carbon foam composed of 40 μm diameter open honeycombs is placed in a chemical vapour deposition CVD furnace.

An approximately 7 μm thick deposition of W—Re 5% alloy obtained from the decomposition of a mix of tungsten and rhenium halide compounds is applied on the ligaments forming the foam.

This foam tube is then inserted into the cladding 1 with inside diameter 7.2 mm, and the column of 6.4 mm diameter fuel pellets 5 is in turn inserted into the foam tube.

The cladding 1 may then be closed at its ends, for example by welding. Even if not shown, before the final closing step is done, a helical compression spring is housed in the expansion chamber or vessel 6 with its lower end bearing in contact with the stack of pellets 5 (possibly an inert packing or spacer not shown) and its other end bearing in contact with the upper plug. The main functions of this spring are to hold the stack of pellets 5 along the direction of the longitudinal axis XX′ and to absorb the elongation of the fuel column with time under the effect of longitudinal swelling of the pellets 5. The nuclear fuel rod thus made with a porous solid joint 3 according to the invention can then be used for application in a nuclear reactor.

Other improvements would be possible without going outside the scope of the invention. Thus, in all examples 1 to 3 mentioned above, the fabrication thickness of the porous solid joint 3, in other words the thickness after the cladding 1 has been closed and the rod is ready for application, is equal to the total design assembly clearance between the cladding 1 and the column of fuel pellets 5.

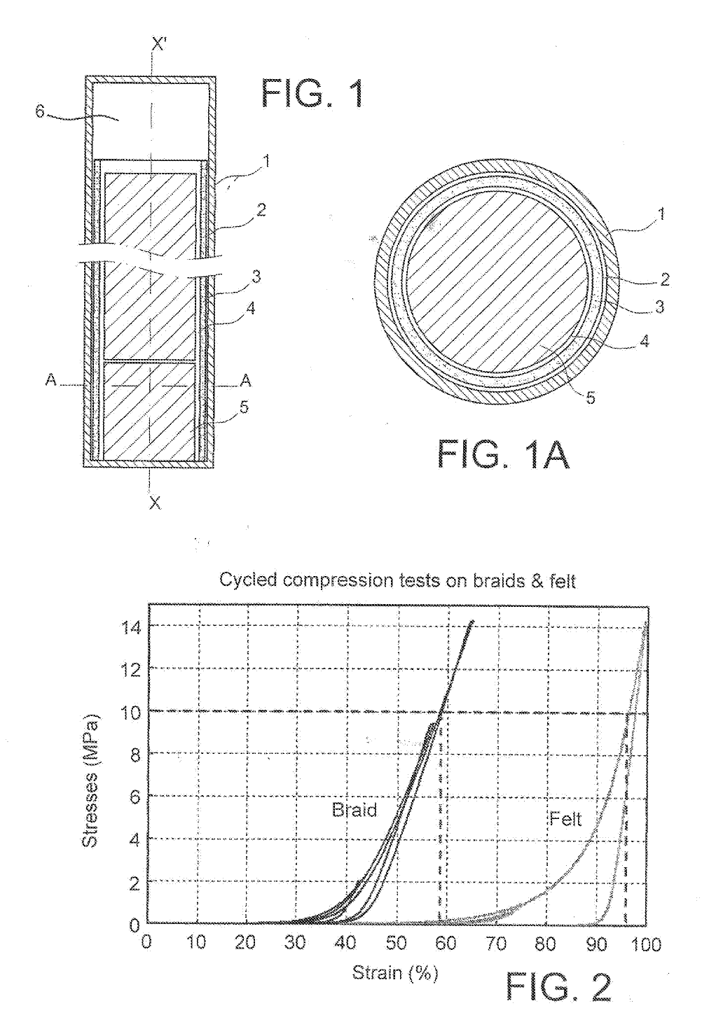

Obviously, clearances could be provided (see references 2, 4 in FIG. 1) that are maintained once the fuel rod is ready, provided that the fabrication methods and properties (particularly differential thermal expansion firstly of the cladding 1 and the porous solid joint 3, and secondly of the joint 3 and the fuel pellets 5) make it possible.

These clearances as shown in references 2, 4 in FIG. 1 are a priori filled with gas, preferably helium for rods. Helium can be pressurised during fabrication to increase the dilution ratio of fission gases released under irradiation and thus improve the thermal performances of the joint and therefore the fuel element. In such cases, the gas then naturally occupies the open pores of the solid porous joint 3 according to the invention, and the open pores of the nuclear fuel pellets 5.

But according to the invention and unlike solutions according to the state of the art, and more particularly the solution according to U.S. Pat. No. 4,235,673, assembly clearances are not essential and therefore are not functional clearances provided to accommodate the three-dimensional swelling of the fuel pellets under irradiation.

Furthermore, the mandrel used to form the porous solid joint as in the examples described may be made of different materials compatible with the materials used in the joint, such as graphite and quartz.

Similarly, for the final step in the process before the cladding is closed, examples 1 to 3 describe placement of a helical compression spring. More generally, during this final step before the step for actual closing of the cladding, it would be possible to use what is currently referred to as an “internals system” in the nuclear domain, in other words an assembly of components such as a spring, spacer, inert packing, etc., the function of which is to position the column of pellets axially within the cladding, and in the case of pressurised coolants, prevent the cladding from buckling (collapse of the cladding onto its expansion vessel).

FIG. 2 shows the compression behaviour of interface joints according to the invention with high open porosity and based on braids or based on felts made of a SiC material.

More precisely, as shown, these are tests in cycled compression, with each cycle alternating a load and an unload, which is shown in FIG. 2 by loading loops in the strain-stress plane.

The abscissa indicates the values of the compression ratio (strain in %) of the joint across its thickness.

The ordinate indicates values of mechanical loads (stress in MPa) transferred by the joint under the effect of its compression.

Thus, the indicated stresses actually correspond to the radial mechanical load σᵣ applied to the cladding of a nuclear fuel rod under the effect of the three-dimensional swelling of fuel pellets stacked on each other, the stresses being transmitted to the cladding directly by compression of the joint between the pellets and the cladding. This radial load introduces a controlling circumferential load σ_{θ}, the intensity of which corresponds to the intensity of the radial load to which a multiplication factor is applied, which is approximately equal to the ratio of the average radius r_{G} of the cladding to its thickness e_{G}, which is typically between 5 and 10: σ_{θ}≈(r_{G}/e_{G}) σᵣ.

FIG. 2 thus illustrates the fact that an interface joint according to the invention is adapted to function like a stress absorber: the transmitted load only becomes significant for a sufficiently high compression ratio beyond which the transmitted load increases progressively with the compression ratio, until it reaches the threshold value of the allowable limiting load (without any sudden changes). Thus, for a load σᵣ considered to be significant starting from 1 MPa, the compression ratio is of the order of 40% and 70% respectively for the braid and felt type joints considered in FIG. 2.

In a situation of operation under irradiation in a reactor, the cladding of a fuel rod cannot resist a mechanical load unless it remains below a limit guaranteeing that there is no cladding failure. Thus, for example if the threshold value of the allowable circumferential load σ_{θ} is fixed at 100 MPa (which is a reasonable value considering usually allowed loads), namely a radial load σᵣ of the order of 10 MPa (for a ratio r_{G}/e_{G} of the order of 10), FIG. 2 shows that braid and felt type joints considered will accommodate a compression ratio of the order of 60% and 95% respectively, below which the mechanical load transmitted to the cladding remains acceptable.

Note that the tests done according to FIG. 2 showed that the interface joint according to the invention based on braids and the joint based on felt maintained their integrity; thus, the braid/felt structure is preserved without any formation of fragments that could move into a reopened gap between pellets and the cladding in a fuel rod.

A fuel rod must be kept in a reactor for as long as possible and at the highest possible power density if economic performances are to be optimised. These performances are usually limited by various operating constraints so as to satisfy safety objectives. One of the most severe constraints is imposed by the need to guarantee mechanical integrity of the fuel rod cladding under all circumstances. This leads to the definition of an allowable limiting load on the cladding (stress and/or strain beyond which the integrity of the cladding can no longer be guaranteed). However under irradiation, the fuel pellets are affected by a continuous three-dimensional swelling that leads to a pellet/cladding mechanical interaction (PCMI) that could eventually lead to an unacceptable load on the cladding. Therefore, the operating life of a fuel rod is strongly dependent on the time for such an excessive interaction to occur. The interface joint according to the invention as defined above provides a satisfactory response because it enables longer term expansion or three-dimensional swelling of the pellets. For a fixed three-dimensional swelling of the pellets, the durability depends on the initial thickness of the joint and the compression ratio that it can accommodate before its compression state causes the transmission of an unacceptable mechanical load to the cladding; the initial thickness of the joint to be installed reduces as the allowable compression ratio increases.

FIG. 2 illustrates the fact that very high compression ratios are necessary to reach the compression limit of the proposed braid or felt type joints, which means that increased irradiation times can be reached if a reasonably thick joint is installed. The inventors believe that typically, for an allowable compression ratio of 60%, an interface joint according to the invention that is twice as thick as joints exclusively in the form of fluids according to the state of the art (helium or sodium, conventionally with a thickness of the order of 4% of the radius of the pellets), could increase the conventional irradiation duration by the order of 20%, which would represent a substantial fuel saving.

Furthermore, shear tests were carried out by imposing forces on an approximately 1 cm thick fibrous structure according to the invention, corresponding to cyclic displacements of the order of 100 μm at temperatures of the order of 400° C. For these elongations of 1%, the fibrous structure remained perfectly intact. The inventors also believe that for usually encountered heights of fuel pellet columns, typically about 165 cm, elongations of the order of 10 cm at usual irradiation temperatures for a fibrous structure according to the invention with an initial thickness of less than 1 millimeter and mechanically decoupled from the column of pellets and also from the cladding, would leave the cladding intact in the long term.

### REFERENCES MENTIONED

[1] S. Audisio, Dépôts chimiques à partir d'une phase gazeuse (Chemical depositions starting from a gaseous phase), Techniques de l'ingénieur, M1660, 1985.
[2] J. Banhart, Manufacture, characterisation and application of cellular metals and metal foams, Progress in Materials Science, Vol. 46, pp. 559-632, 2001.
[3] A. Berthet, B. Kaputsa, R. Traccucci, P. Combette, F. couvreur, D. Gouaillardou, J. C. Leroux, J. Royer & M. Trotabas, Pressurized Water Reactor Fuel Assembly, in The nuclear fuel of pressurized water reactors and fast reactors—Design and behaviour, (H. Bailly, D. Menessier and C. Prunier, Editors), Lavoisier Publishing, Paris, pp. 271-436, 1999.
[4] L. Caramaro, Textiles à usages techniques (Fabrics for Engineering Applications), Techniques de l'ingénieur N2511, 2006.
[5] Y. Guérin, In-reactor behaviour of fuel materials, in The nuclear fuel of pressurized water reactors and fast reactors—Design and behaviour, (H. Bailly, D. Menessier and C. Prunier, Editors), Lavoisier Publishing, Paris, pp. 77-158, 1999.
[6] L. Kocon and T. Piquero, Les aérogels et les structures alvéolaires: deux examples de mousses de carbone (Aerogels and honeycomb structures: two examples of carbon foam), L'Actualité Chimique, No. 295-296, pp. 119-123, 2006.
[7] J. Y. Malo, N. Alpy, F. Bentivoglio, F. Bertrand, L. Cachon, G. Geffraye, D. Haubensack, A. Messié, F. Morin, Y. Péneliau, F. Pra, D. Plancq & P. Richard, Gas Cooled Fast Reactor 2400 MWTh, status on the conceptual design studies and preliminary safety analysis, Proceedings of the ICAPP'09 conference, (Tokyo, Japan, May 10-14, 2009).
[8] R. B. Matthews and R. J. Herbst, Nuclear Technology, Vol. 63, pp. 9-22, 1983.
[9] Hj. Matzke, Science of advanced LMFBR fuels, North Holland, Amsterdam, 1986.
[10] P. Millet, J. L. Ratier, A. Ravenet and J. Truffert, Fast Reactor Fuel Subassembly, in The nuclear fuel of pressurized water reactors and fast reactors—Design and behaviour, (H. Bailly, D. Ménessier and C. Prunier, Editors), Lavoisier Publishing, Paris, pp. 437-529, 1999.
[11] K. Tanaka, K. Maeda, K. Katsuyama, M. Inoue, T. Iwai and Y. Arai, Journal of Nuclear Materials, Vol. 327, pp. 77-87, 2004.
[12] Design and construction rules for fuel assemblies of PWR nuclear power plants, AFCEN, 2005.

1. Nuclear fuel rod extending along a longitudinal direction (XX′), comprising a plurality of fuel pellets, stacked on each other in the form of a column and a cladding made of a material transparent to neutrons, surrounding the column of pellets, in which the cladding and the pellets have a circular cross-section transverse to the longitudinal direction (XX′), and in which an interface joint, also with a circular cross-section transverse to the longitudinal direction (XX′), made of a material transparent to neutrons, is inserted between the cladding and the column of stacked pellets, at least over the height of the column, characterised in that the interface joint is a solid structure mechanically decoupled from the cladding and from the column of pellets, with a high thermal conductivity and open pores, this solid structure having a sufficiently high coefficient of thermal conductivity to transfer heat between the column of pellets and the cladding and being adapted to deform by compression across its thickness so as to be compressed under the effect of the three-dimensional swelling of the pellets under irradiation, the initial thickness of the joint and its compression ratio being such that the mechanical load transmitted to the cladding by the pellets under irradiation is less than a predetermined threshold value.

2. Nuclear fuel rod according to claim 1, in which the open pores of the interface joint have a volume equal to at least 30% of the total volume of the interface joint as produced in fabrication.

3. Nuclear fuel rod according to claim 2, in which the open pores of the interface joint have a volume between 30% and 95% of the total volume of the interface joint as produced in fabrication.

4. Nuclear fuel rod according to claim 3, in which the open pores of the interface joint have a volume between 50% and 85% of the total volume of the interface joint as produced in fabrication.

5. Nuclear fuel rod according to claim 1, in which the thickness of the interface joint in its section transverse to the (XX′) direction is more than at least 4% of the radius of the pellets.

6. Nuclear fuel rod according to claim 1, in which the interface joint is composed of one or several fibrous structures such as braid(s) and/or felt(s) and/or web(s) and/or fabric(s) and/or knit(s).

7. Nuclear fuel rod according to claim 6, in which the interface joint composed of fibrous structure(s) has a volume percentage of fibres between 15 and 50%.

8. Nuclear fuel rod according to claim 6, in which the interface joint is made from a braid comprising a carbon fibre layer and a layer comprising silicon carbide fibres superposed on the carbon fibre layer.

9. Nuclear fuel rod according to claim 1, in which the interface joint is made from one or several honeycomb materials such as foam.

10. Nuclear fuel rod according to claim 1, in which the interface joint is based on ceramic.

11. Nuclear fuel rod according to claim 1, in which the interface joint is based on metal.

12. (canceled)

13. (canceled)

14. (canceled)

15. Nuclear control rod according to claim 1, in which the solid joint with open pores, has a height greater than the height of the column of stacked pellets, the difference in height between the solid joint and the of stacked pellets being selected to guarantee that the column of pellets remains facing the joint axially throughout the irradiation phase during operation of the nuclear reactor in which the fuel rod will be used, the column of pellets being submitted to an elongation by swelling under irradiation during the irradiation phase.

16. (canceled)

17. (canceled)

18. Method for making a nuclear fuel rod, comprising the following steps:
a/ at least partially make a joint with a circular cross-section made of a material transparent to neutrons, in the form of a structure with high thermal conductivity with open pores, capable of deforming under compression across its thickness;
b/ insert the at least partially produced joint into a cylindrical cladding with a circular cross-section that is open at least at one of its ends, made of material transparent to neutrons;
c/ insert a plurality of nuclear fuel pellets over not more than the height of the joint, inside the joint inserted into the cylindrical cladding with circular cross-section;
d/ completely close the cladding once the joint has been entirely produced.

19. Production method according to claim 18, according to which step a/ is performed using the following sub-steps:
superpose a braid layer comprising silicon carbide fibres on a carbon fibre braid layer itself on a mandrel;
compress the two-layer braid in a cylindrical mould;
add a soluble binder into the compressed braid;
evaporate the solvent;
according to which step b/ is performed using the mandrel around which the braid is in contact;
and according to which later in step c/, a heat treatment is performed under a vacuum to eliminate the binder and thus bring the joint into contact with the plurality of stacked pellets and with the cladding.

20. Production method according to claim 19, according to which the braid layers are of the two-dimensional type with a braiding angle of 45° relative to the axis of the mandrel.

21. (canceled)

22. (canceled)

23. (canceled)

24. Production method according to claim 18, according to which step a/ is performed using the following sub-steps:
needlebonding of carbon fibre webs in the form of a tube on a mandrel;
performance of a heat treatment;
compression of the heat-treated tube in a cylindrical mould;
addition of a soluble binder into the compressed tube;
evaporation of the solvent;
according to which step b/ is performed using the mandrel around which the tube is in contact,
and according to which later in step c/, a heat treatment is performed under a vacuum to eliminate the binder and thus bring the joint into contact with the plurality of stacked pellets and with the cladding.

25. (canceled)

26. (canceled)

27. Production method according to claim 18, according to which step a/ is performed using the following sub-steps:
production of a carbon foam tube composed of open honeycombs;
chemical vapour deposition (CVD) of a W—Re alloy on the carbon foam tube.
